(19) United States
(12) Patent Application Publication
(10) Pub. No.: US 2026/0200359 A1
(43) Pub. Date: Jul. 16, 2026

(54) A MOBILE AUTONOMOUS CHARGING SYSTEM FOR ELECTRIC VEHICLES AND METHOD OF USING THEREOF

(71) Applicant: BATTERI THOMAS LTD., Tel Aviv (IL)

(72) Inventors: Tomer SHAHAF, Tel Mond (IL); Tamar BEZALEL BURSHTEIN, Tel Aviv (IL); Ram ROTBART, Tel Aviv (IL); Yossi BURSHTEIN, Tel Aviv (IL)

(21) Appl. No.: 18/871,220

(22) PCT Filed: Jun. 8, 2023
(86) PCT No.: PCT/IL2023/050592

§ 371 Date: Dec. 3, 2024

Related U.S. Application Data
(60) Provisional application No. 63/350,505, filed on Jun. 9, 2022.

(51) Int. Cl. B60L 53/37; B60L 53/10; B60L 53/126; B60L 53/18; B60L 53/38; B60L 53/62; B60L 53/63; B60L 53/64; B60L 53/65; B60L 53/66; B60L 53/67; B60L 53/68; B60L 53/80

(52) U.S. Cl. CPC B60L 53/37; B60L 53/11; B60L 53/126; B60L 53/18; B60L 53/38; B60L 53/62; B60L 53/63; B60L 53/64; B60L 53/65; B60L 53/66; B60L 53/67; B60L 53/68; B60L 53/80; B60L 2240/622; B60L 2250/16

(57) ABSTRACT

There are provided systems and methods for an autonomous and mobile charging system for electric vehicles (EVs). The system comprises a reversed “L” shape charging cart with a laying part and a standing part, designed to be positioned under an EV such that the laying part is fully positioned under the EV and a processor executing a code configured to manage the charging of the EV, the charging queue and the charging of the provided charging system.

### TECHNICAL FIELD

The present disclosure, in some embodiments thereof, relates to charging systems. More specifically, but not exclusively, to mobile autonomous charging systems for electric vehicles with a management system including optimized self-charging capabilities.

### BACKGROUND

The automotive world is moving rapidly from internal combustion engines (ICE) vehicles towards Electric vehicles (“EV's”), which are less expensive for maintenance and more environmentally friendly.

To support this transition to EV's there are needs to find solutions for the charging infrastructures.

The first existed solution is to provide a charging unit, which is non-mobile, and which is embedded into a parking spot in a building. However, if a person doesn't have a fixed parking spot, this solution cannot be used. Alternatively, if other persons (or all persons) have an EV in a building and they need to use the charging unit as well, there is a need for a system to manage the charging queue.

Another challenge is the long time period the charging of an EV takes, which makes it difficult to manage the charging queue taking into consideration different drives that should be done by different EV including long trips sometimes, which requires a full charge of the EV and which may take at least a few hours. Another problem with a home parking spot is the fact it is not economical for charging infrastructure.

A different solution existing today is a gas station with rapid chargers for EV (supercharger stations). However, the fast charging takes about 60 minutes a week at a supercharger station which is still a long time the user must wait for the charge to be done, not including the time that has to be spent waiting in the gas station queue. Additionally, not all gas stations are supercharger stations, and for persons who have no supercharger stations in their way home or at their home environment this solution doesn't work.

Another possible solution may be to provide slow charging units at public parking lots such as at work-places parking lots, train stations parking lots, or shopping centers parking lots. Yet, this solution is very expensive and not economic. First, these charging units may be utilized about 10% of the day as, usually an EV charging takes between two to three hours, but the parking duration is longer and may get to 8 to 10 hours, and since ICE (internal combustion engines) vehicles may also park in the charging units parking spots. In addition, these parking spots are usually located far from the rest of the parking spots and it takes time to find it, and a special cable needs to be purchased and carried by the user in order to connect the EV to the charging unit. Also, the price of new electric infrastructure to build across the parking lot and the price of the charging unit makes the price of the charging very high, and all of the above options usually charge the EV during daytime, when electricity prices are higher.

There is therefor, a need to provide a charging system which is fast yet does not increase the charging infrastructures cost and so keeps maintenance of an EV cost effective.

### SUMMARY

According to some embodiments of the present disclosure, provided herein are methods and systems for charging Electric Vehicles (EVs) with a mobile autonomous charging system with a reversed “L” shape charging cart which is adjusted to be positioned during use under the charged vehicles.

According to some embodiments of the present disclosure, the charging system, comprises an autonomous automatic DC charger that may charge any vehicle, by wire or wireless DC fast charging, adapted to the battery charging rate (i.e., to eliminate damage of the battery) in every parking spot using an onboard battery of the charging system that was charged in advance when the electricity prices were low, and the infrastructure of the building or parking lot had enough to spare.

According to some embodiments of the present disclosure, in order to use the charging system a user needs to subscribe through a dedicated application installed in the user's mobile device. According to some embodiments, when EVs subscribed to the application enter a parking lot that they visit frequently, and where the charging system is installed, a notification is sent in the app. The app, which includes a charging management module using business intelligence (BI) and artificial intelligence (AI), then schedules an optimal charging time slot for the EV, considering the battery status, the typical time the user of the EV leaves the parking lot, and the other EV's that are currently in the parking lot, such that, every time the EV must leave at the end of the day or any other time, The EV is charged up according to the EV's user requirements (for example, up to 70% or 80%) and is ready to go.

According to some embodiments of the present disclosure, when a subscribed EV comes into a random parking lot where the charging system is installed, the user of said EV gets notified that the charging system is available in this parking lot. The user of the EV can then choose if he wants to charge and when they are scheduled to leave in order to let the charging system to set a time for a charging slot. Advantageously, this way electric and infrastructure costs are saved and the EV may park anywhere with no limitations. Also, the need of carrying the special cable is redundant.

Advantageously, according to some embodiment the herein described charging system provides charging solutions for EVs that lower the cost of electricity, lower the need for expensive infrastructure and lower the influence of the charging on the electric connection to the grid.

In one aspect an autonomous and mobile charging system for electrical vehicles (EVs), is disclosed. The charging system comprises a reversed “L” shape charging cart comprising a lying part and a standing part wherein the lying part is longer than the standing part, and wherein the lying part is designed to be positioned under an EV while charging said EV; wherein said lying part comprises a battery and/or charging surface which is replaceable according to the EV type, energy and dimensions requirements; and wherein the standing part comprises a positioning sensor; and
a processor configured to execute a code for managing charging of the EV by the charging system configured to:
   identify a subscribed EV entering to a parking lot;
   receive data from the EV or from a mobile device of said EV's user regarding charging state of said EV;
   track said EV parking location using the positioning sensor;
   send the charging cart to said EV's parking location to charge said EV; and
   automatically return the charging cart to a charging station and optimally charging the charging cart by prioritizing charging in low-price hours and low electricity consumption hours.

According to some embodiments, subscription of an EV to the system is done through a dedicated application installed in the mobile device of the EV's user.

According to some embodiments, the charging system further comprises cables for connecting the EV to the charging system for charging the EV.

According to some embodiments, the charging surface is wireless for charging the EV wirelessly.

According to some embodiments, the charging cart further comprising a DC charger, for rapid charging.

According to some embodiments, the standing part of the charging cart comprises an operating panel interface for operating the charging system.

According to some embodiments, the operating panel interface comprises a screen.

According to some embodiments, the screen is a touch screen.

According to some embodiments, the screen is an LCD screen.

According to some embodiments, the position sensor is a Lidar sensor.

According to some embodiments, the position sensor is a GPS sensor.

According to some embodiments, identifying a subscribed EV is done using LPR or GEO fencing.

According to some embodiments, identifying a subscribed EV is done manually by the user, entering the EV's parking spot to the dedicated application.

According to some embodiments, the charging cart further comprises one or more back-up batteries for replacing an empty battery, wherein while the battery is charging the EV, the back-up batteries are charged.

According to some embodiments, the processor is a local processor.

According to some embodiments, the processor is a remote server.

According to some embodiments, the processor is a part of a cloud computing network.

According to some embodiments, the processor is further configured to execute a code configured to:
a. identify a plurality of subscribed EV located at the parking lot;
b. receive additional information about the duration of parking and future travels and/or trips of the EV and creating a charging queue for the plurality of subscribed EVs in the parking lot, according to the received charging data and according to said received additional information;
c. track the parking location of the first EV in the charging queue, using one or more positioning sensors;
d. send the charging cart to said first EV's parking location, charging said first EV and removing the charged EV from the charging queue after the charging of the EV is done; and
e. repeat steps c and d until the charging queue is empty.

In a second aspect, a method for managing an electric vehicle (EV) charging by the charging system is disclosed. The method comprises:
identifying a subscribed EV entering to a parking lot;
receiving information from the EV or from a mobile device of said EV user regarding charging state of said EV;
tracking said EV parking location using one or more positioning sensors; and
   sending the charging cart to said EV's parking location to charge said EV; and
   automatically returning the charging cart to a charging station and optimally charging the charging cart by prioritizing charging in low-price hours and low electricity consumption hours.

According to some embodiments, the method further comprises the steps of:
a. identifying a plurality of subscribed EV located at the parking lot;
b. receiving additional information about the duration of parking and future travels and/or trips of the EV and creating a charging queue for the plurality of subscribed EVs in the parking lot, according to the received charging data and according to said received additional information;
c. tracking the parking location of the first EV in the charging queue, using one or more positioning sensors;
d. sending the charging cart to said first EV's parking location, charging said first EV and removing the charged EV from the charging queue after the charging of the EV is done; and
e. repeating steps c and d until the charging queue is empty.

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

### BRIEF DESCRIPTION OF THE DRAWINGS

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not drawn to scale. Moreover, two different objects in the same figure may be drawn to different scales. In particular, the scale of some objects may be greatly exaggerated as compared to other objects in the same figure.

### IN THE FIGURES

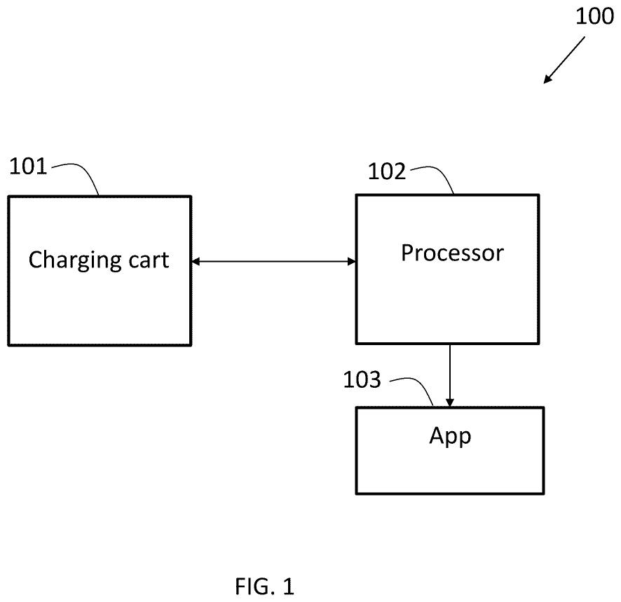

FIG. 1 schematically shows a block diagram of a charging system for mobile, autonomous charging of EV's including a charging management module, according to some embodiments.

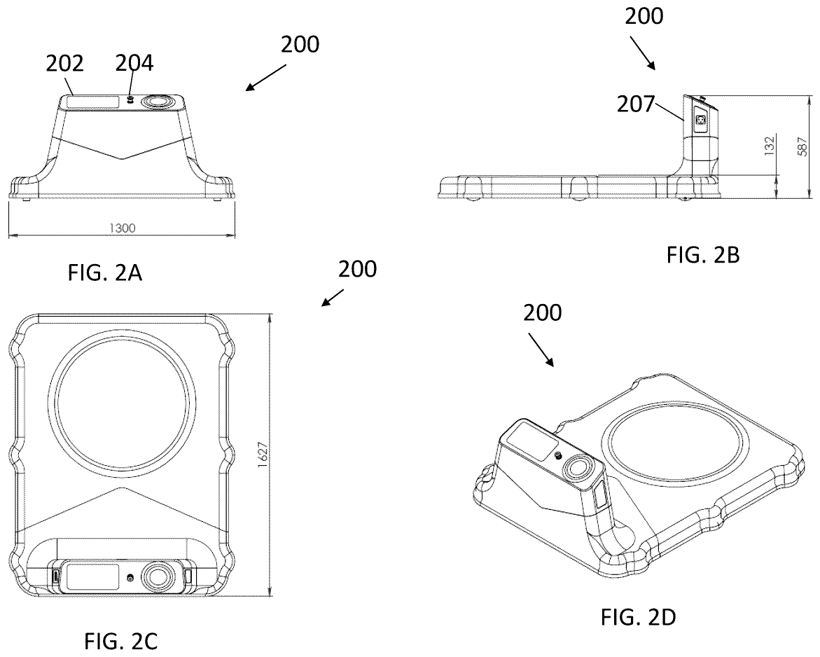

FIGS. 2A-2D schematically show a mobile autonomous charging system for electric vehicles (EVs) from a front view, side view, top view and a perspective view respectively, according to some embodiments;

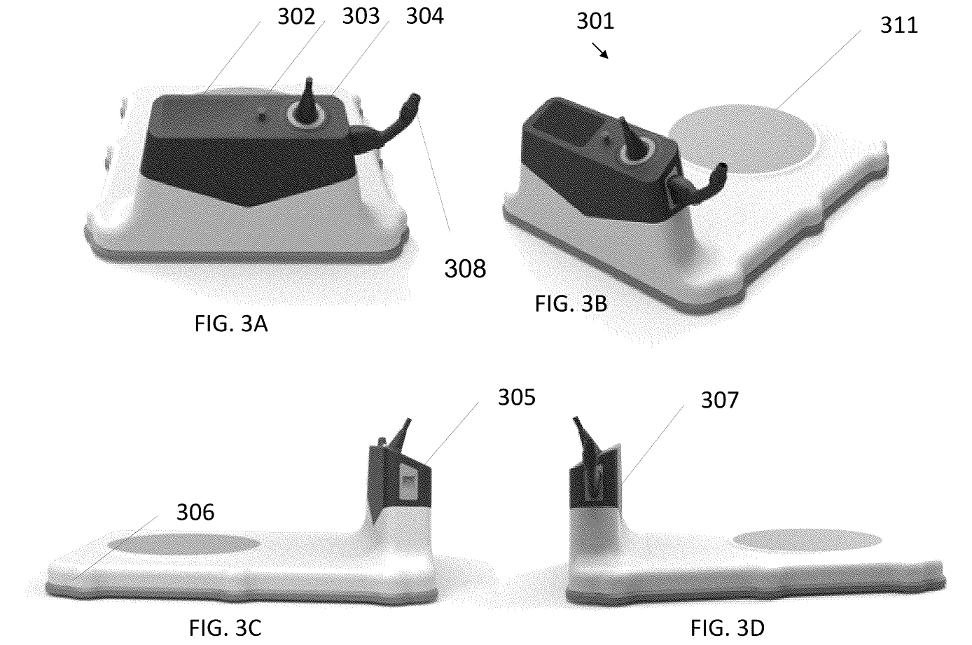

FIGS. 3A-3D schematically show an example of a mobile autonomous charging system for electric vehicles (EVs) from a rare-perspective view, perspective view, left-side view and a right-side view respectively, according to some embodiments;

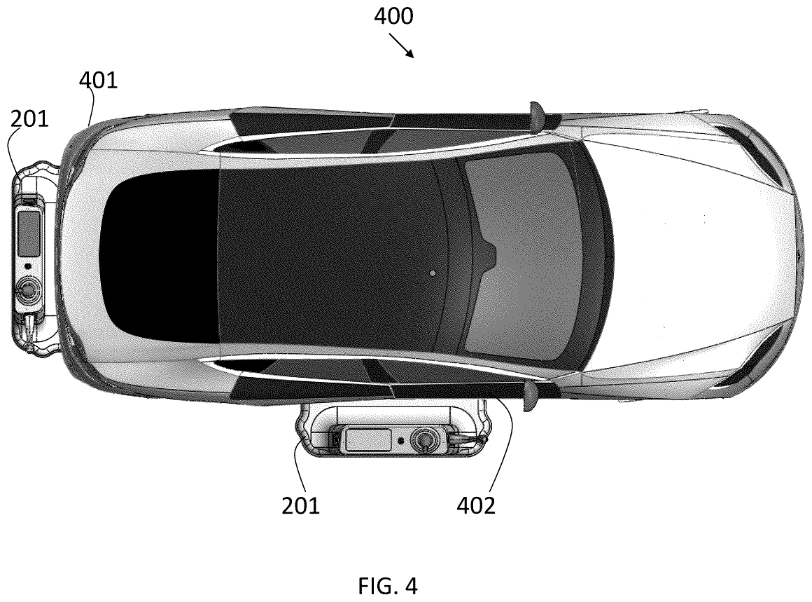

FIG. 4 schematically shows a top view of an example of using a mobile autonomous charging system for electric vehicles (EVs) during the charging, according to some embodiments;

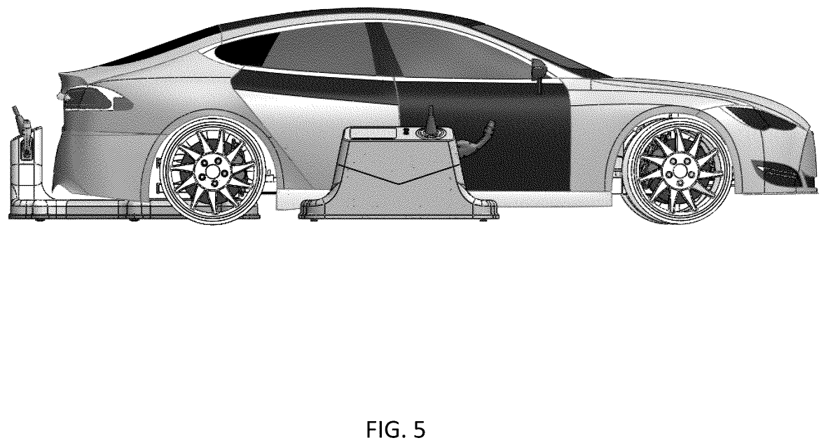

FIG. 5 schematically shows a side view of an example of using a mobile autonomous charging system for electric vehicles (EVs) during the charging, according to some embodiments;

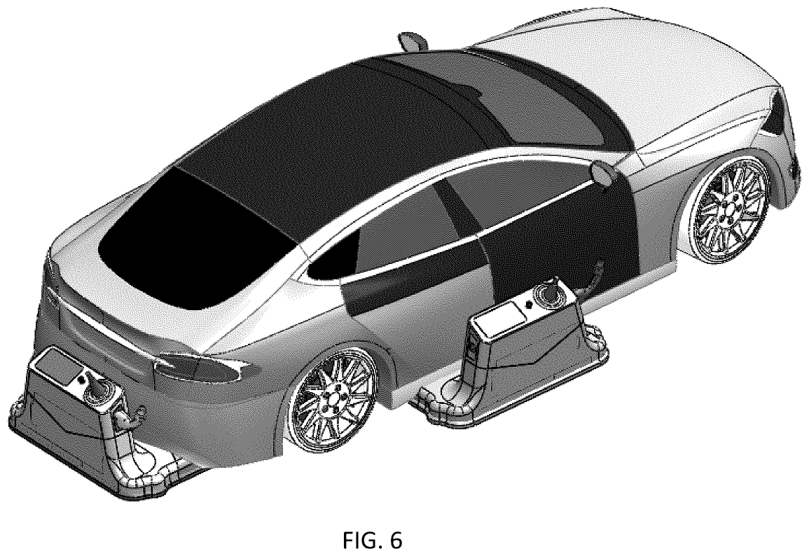

FIG. 6 schematically shows a perspective view of an example of using a mobile autonomous charging system for electric vehicles (EVs) during the charging, according to some embodiments;

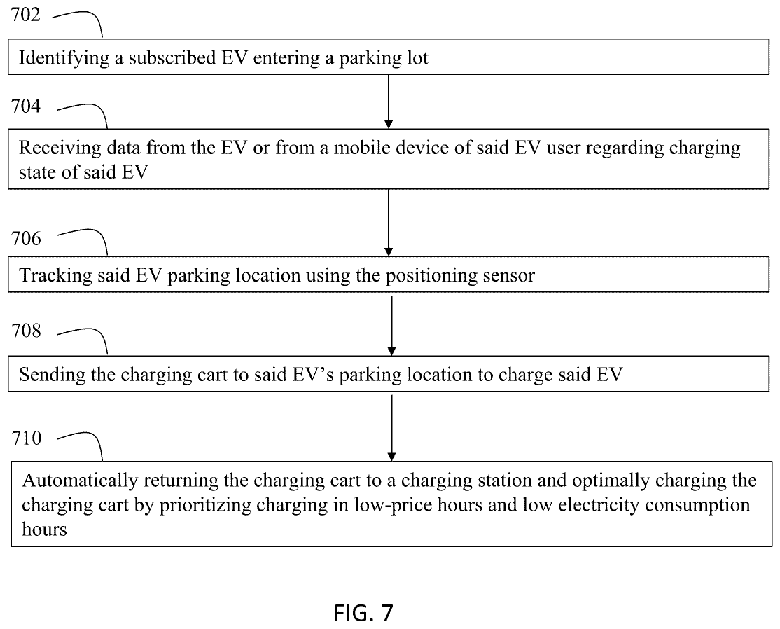

FIG. 7 schematically shows a flow chart of a method for managing an EV charging by an autonomous mobile charging system, according to some embodiments; and

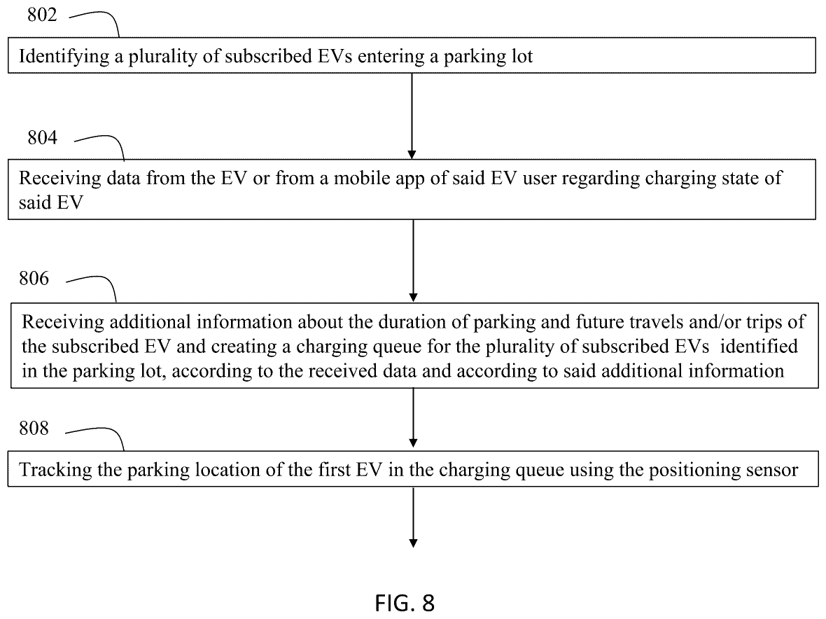

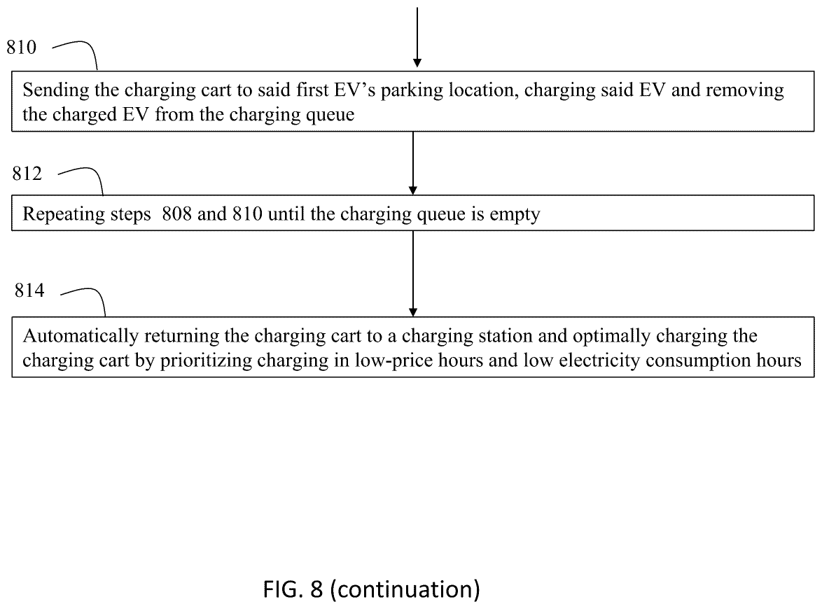

FIG. 8 schematically shows a flow chart of a method for managing a charging queue for EV charging by an autonomous mobile charging system, according to some embodiments.

### DETAILED DESCRIPTION

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

According to some embodiments, provided herein are advantageous systems for mobile, autonomous charging of electric vehicles (VEs) and methods of using thereof. The systems include a charging management module, which manages the charging of the EV's, the charging queue and the charging of the system itself.

Reference is now made to FIG. 1 which schematically shows a block diagram of a charging system for mobile, autonomous charging of EV's including a charging management module, according to some embodiments. System 100 includes a charging cart 101, a processor 102 and a dedicated application (app) 103. Charging cart 101 is in a shape of a reversed “L” with a laying part and a standing part, where the laying part is longer than the standing part. Charging cart 101 is mobile and autonomous and enables charging EVs. The reversed “L” shape structure of cart 101 enables to charge the EV while cart 101 is positioned under the EV, thereby requiring almost no extra space of the parking lot for the charging cart. According to some embodiments, charging cart 101 is provided with a DC charger which is a fast charger for rapidly charging the EVs during less than one hour.

According to some embodiments, the laying part of cart 101 includes a skate which is mounted on the laying part of cart 101 and which includes a battery for charging the EVs. In addition, the laying part includes a charging surface such as a pad for charging the EV wirelessly. The battery and/or charging surface are replaceable according to the EV type (for example, private car, track, commercial car and the like) and according to energy requirements (total on board energy [kWh]) and physical dimension requirements (mainly the height of the battery which is constrained by the ground clearance of the vehicle).

According to some embodiments, the application 103 includes a charging management module, which is executed by processor 102. Processor 102 executes a code configured to manage the charging of the EV, the charging queue and the charging of the battery for charging the EV. Processor 102 may be locally embedded within charging cart 101 or alternatively, processor 102 may be remote, such as a remote server. Additionally, or alternatively, processor 102 may be a part of a cloud computing network.

According to some embodiments, charging cart 101 includes at least one battery for charging the EVs. According to some embodiments, advantageously, the charging management module manages the charging time of the battery to be during hours in which the electricity consumption and cost is low (for example during nights) such that charging the battery does not burden the electricity network and is cost effective. According to some embodiments, the charging system is charged at a dedicated fast charging position so that the charging of the charging system is rapid and may take less than an hour. According to some embodiments, charging cart 101, includes one or more additional batteries using as a back-up in case the battery used for charging the EV is discharged or out of use such that at least one battery is always fully charged and available for use. According to some embodiment, the charging of a discharged battery may be done during the charging of an EV, such that one battery is charging the EV, while the one or more additional batteries are being charged via the electricity network. According to some embodiments, the one or more additional batteries are mounted to the laying part of charging cart 101 and are easily replaceable with the battery used for charging the EV which is also mounted to the laying part of charging cart 101.

FIGS. 2A-2D, schematically show an example of a mobile autonomous charging cart 201 for electric vehicles (EVs) from a front view, side view, top view and a perspective view respectively, according to some embodiments. Charging cart 201 comprises a reversed “L” shape cart which is mobile and autonomous and, which enables charging EVs. The reversed “L” shape structure of the cart enables to charge the EV while charging cart 201 is positioned under the EV, thereby, requiring almost no extra space of the parking lot for charging cart 201. According to some embodiments, since charging cart 201 is designed to be positioned under the EV during charging, it may include a wireless charging surface, which charges the EV without any cables and so preclude the need for an operator to physically connect charging cart 201 to the EV.

According to some embodiments, the cart size may be between about 1000 mm-1500 mm width, and 1500 mm-1900 length. According to some embodiments, the size of cart 201 may be as shown in FIGS. 1A-1D, about 1300 mm width, 1627 mm length, 587 mm height and thickness of 132 mm. According to some embodiments, the size of cart 201 may be about 1100 mm width, 2000 mm-3000 mm length, 1000 mm height and thickness of about 120 mm. According to some embodiments the thickness of cart 201 maybe adapted to the ground clearance of the EV, for example, by using a thick battery, such that the total thickness of charging cart 201 is smaller than the ground clearance of a specific EV.

According to some embodiments, charging cart 201, in its standing part, includes a touch screen interface 202 for operating charging system 200, an emergency stopping component 204, one or more cables (not shown) for charging the EVs wirely and an autonomous motion Lidar 207. Charging cart 201 also includes handles for manual operation, motorized wheels, wheels brakes and proximity sensors and battery compartments (not shown). According to some embodiments, touch screen interface 202 may be for example an LCD screen. According to some embodiments, autonomous motion Lidar 207 is used to allow cart 201 to move autonomously in space without colliding objects and people in its environment. According to some embodiments, the proximity sensors help to calculate the distance between charging cart 201 and the EV to be charged.

Reference is now made to FIGS. 3A-3D, which schematically show an example of a mobile autonomous charging cart 301 for electric vehicles (EVs) from a perspective view, rare-perspective view, left-side view and a right-side view respectively, according to some embodiments.

FIG. 3A schematically shows the rare-perspective view of the example of charging cart 301, according to some embodiments. The rare-perspective view of cart 301 present the standing part of the cart 301. The standing part includes an operating panel user interface 302, an emergency stop button 303 and a cable outlet 304. Operating panel user interface 302 is presented as a touch screen (may be for example an LCD screen) and allows a user to operate charging cart 301. In the screen, a level of charging of the EV's battery may be shown. Emergency stop button 303 activates an emergency stopping component, which stops the charging cart movement. Pedestal 308, is used to place on a charging cable, when the cable is not connected to an EV.

In FIG. 3B a wireless charging surface 311 is shown. Charging surface 311 is located at the laying part of cart 301 which is configured to enter under the EV and therefore enables a wireless charging of the EV. According to some embodiments, the battery compartment is also located at the laying part of cart 301. Both the battery compartment and charging surface 311 are replaceable according to the EV type (for example, private car, track, commercial car and the like) and according to energy requirements (total on board energy [kWh]) and physical dimension requirements (mainly the thickness of the battery which is constrained by the ground clearance of the vehicle).

In FIG. 3C where a schematic left-side view is presented a wall power 305 is shown, and a protective bumper 306, for protecting charging cart 301 when said charging cart stops moving. FIG. 3D schematically shows a right-side view of charging cart 301, where Lidar sensor 307 is presented.

FIG. 4 schematically shows a top view of an example of using a mobile autonomous charging system for electric vehicles (EVs) during the charging an EV, according to some embodiments. As can be seen, charging cart 201 may be positioned under the rare part 401 of EV 400 or under the middle part 402 of the EV 400. According to some embodiments, the middle part of the EV may be on the left side of the EV or on the right side of the EV. According to some embodiments, charging cart 201 may be positioned under the front part of EV 400 (not shown).

FIG. 5 schematically shows a side view of an example of using a mobile autonomous charging system for electric vehicles (EVs) during the charging, according to some embodiments.

FIG. 6 schematically shows a perspective view of an example of using a mobile autonomous charging system for electric vehicles (EVs) during the charging, according to some embodiments.

According to some embodiments a method of use of the charging system is disclosed herein. According to some embodiments, a subscription of the EV through a dedicated application (app) is required in order to be identified by the charging system. According to some embodiments, at the subscription stage a user provides the EV license number, and details about the EV's charging requirements, for example, a maximum daily charging percentage (usually it is recommended to charge up to 80% for daily use, however when a long trip is planned a full charge of about 100% is recommended), a total capacity of the EV battery, battery chemistry such as Lithium Iron Phosphate (LFP), Nickel Manganese Cobalt (NMC) or others, and the like.

In addition, further information regarding the user may be provided through the app by the user, such as the user's role and seniority. According to some embodiments, an access to the user's schedule may be provided to allow an effective charging management and queue management of the EV during parking time of the EV. For example, if a user came to a meeting of about one hour the EV is in the parking lot only for one hour and therefor, said EV receives higher priority in the charging queue management than other EVs which are parking for a whole working day. Moreover, the EV's battery status is also one of the priority considerations and an EV with an almost empty battery receives higher priority than other EV's with higher percent of charged battery.

Reference is now made to FIG. 7, which schematically shows a flow chart of a method for managing an EV charging by an autonomous mobile charging system, according to some embodiments. At step 702, a subscribed EV entering a parking lot is identified by charging system 100. According to some embodiments, the identification may be done for example using license plate recognition (LPR) camera or GEO fencing. Alternatively, the identification of the subscribed EV may be done manually by the user, entering the EV's parking spot to the dedicated application, i.e., the user enters the name of the parking lot, the number of floor and the number of parking spot. For example: Parking lot “Atidim”, Floor 3, parking spot 123. According to some embodiments, the charging system may be located at any place which provides parking places for EV, for example, companies with large fleets and parking lots, real estate owners with large parking spaces, buildings with limited electric connection that wants to charge EV's, car rental companies that have huge parking lots and don't want to install many chargers, airports parking lot, where people leave their EV at the airport parking lot for a few weeks and want the EV to be charged up and ready to go when they come back, cities that wish to avoid bulky charging stations all over their sidewalks, and look for a more esthetical solution for the EV charging and the like.

At step 704, data regarding the charging state of said identified EV is received from the EV or from a mobile device of said EV's user through the app. The data includes the type of EV, type of battery, level of charging of the battery of the EV and the like. According to some embodiments, at step 706, the EV's parking location is tracked by the system using the positioning sensor(s) located at charging cart 101, for example by using the GPS sensor located on the charging cart 101 or by using the Lidar sensor located at charging cart 101. According to some embodiments, the location of the EV may also be provided manually by the user, entering the EV's parking spot to the dedicated application, i.e., the user enters the name of the parking lot, the number of floor and the number of parking spot. For example: Parking lot “Atidim”, Floor 3, parking spot 123. According to some embodiments, at step 708, charging cart 101 is sent to the location of the identified EV and charges said EV. Charging cart 101 is autonomous and moves autonomously to the location of the identified EV. According to some embodiments, the identification and/or tracking of location of an EV may also be done by charging cart 101 while moving in the parking lot, for example whet charging cart 101 is in its way to charge an EV in the parking lot. In this case, charging cart 101 identifies the vehicles surrounding it and tracks the locations of the identified EV's which are subscribed to charging system 100.

According to some embodiments, the charging battery used for charging the EV is adapted to the charging requirements of the EV, for example, the type of the EV, the total energy required in kWh and the physical dimensions required to allow the positioning of charging cart 101 under the EV (such as the ground clearance of the EV). According to some embodiments, the charging may be done wirely using cables provided with charging cart 101 and connecting the EV to the wall power of charging cart 101 (such as wall power 305 shown in FIG. 3C). Alternatively, or additionally, the charging may be done wirelessly using the charging surface located at the laying part of charging cart 101 and positioned under the EV. According to some embodiments, at step 710, once the charging of the EV is completed, charging cart 101 is automatically returning to a charging station of charging system 100. In the charging station charging cart 101 may be in standby waiting for another EV charge or it may be charged to have fully charged batteries. The charging of charging cart 101 is managed by the charging management module which optimizes the charging of cart 101, by prioritizing charging of charging cart 101 in hours where the electricity consumption and price is low. When the charging management module decides charging cart 101 needs to be charged, or once the charging cart is on a very low battery level, charging cart 101 is taken automatically or manually to the dedicated charging position to be recharged by connecting to the electricity grid.

According to some embodiment, when charging cart 101 is fully charged it is able to charge with the same battery more than one EV, before it needs to be recharged. For example, charging cart 101 may be able to charge up to 4 EVs, 5 EVs, 6 EVs, 7 EVs, 8 EVs, each is a separate embodiment. According to some embodiments, the battery of charging cart 101 may of 40 kWh-80 kWh, while an average EV needs between 10-12 kWh. In addition, according to some embodiments, the one or more back-up batteries of charging cart 101 may be charged during charging an EV, such that one battery is charging the EV and the one or more back-up batteries are charged so that once the charging battery is discharged, the back-up battery(ies) is fully charged and can replace the discharged battery, without needing to wait the time of recharging the charging battery for charging another EV.

According to some embodiments, the charging system is automatically operated by the charging management module, or alternatively may be manually operated by an operator. For example, the operator may move or drive the charging system to the located parking position of the EV. After the charging of the EV is done, the charging system may be taken to charge another EV.

According to some embodiments, the charging system (such as charging system 100) may include more than one charging cart and in this case the charging management module also manages the charging carts, so as to decide which charging cart to sent for charging an EV according to different considerations such as, distance of the EV from the charging carts, battery status of the EV and battery status of the charging carts and the like.

According to some embodiments, the charging management module also manages a charging queue when there are more EVs than charging carts available in the charging system. Reference is now made to FIG. 8, which schematically shows a flow chart of a method for managing a charging queue for EV charging by an autonomous mobile charging system, according to some embodiments. At step 802, a plurality of subscribed EVs are identified in a parking lot, wherein there are more subscribed EVs for charging than available charging carts (such as charging cart 101 or 201 or 301). In this case, in order to charge all the EVs, a charging queue has to be created and managed. At step 804, data regarding the charging state of the identified EVs is received from each identified EV or from a mobile app of said EV user. In addition, at step 806, additional information about the duration of parking and future travels and/or trips of each of the identified EVs is received and a charging queue is created for the plurality of identified subscribed EVs in the parking lot, according to the charging data and according to said additional information. According to some embodiments, the priority in the charging queue is determined by parameters like duration of parking, when the EV that parks for the minimal time receives high priority at the time slot said EV is at the parking lot. For example, an EV that is planned to park for about one hour due to a meeting of the EV's user scheduled for one hour, receives higher priority than an EV that is planned to park a whole working day in the parking lot. Moreover, a high priority may be given to an EV with a very low charging level over an EV which is half charged or almost fully charged. Another parameter taken into consideration is a near future travel and/or trip which requires a full charge of the EV. In this case the EV planned to travel receives higher priority in the charging queue over EVs with no future travel/trips planned information.

At step 808, according to some embodiments, the location of the first identified EV in the charging queue is tracked, using the positioning sensors of the charging cart such as the GPS sensor, or Lidar sensor. According to some embodiments, the location of the first EV in the charging queue may also be provided manually by the user, entering the parking spot to the dedicated application, i.e., the user enters the name of the parking lot, the number of floor and the number of parking spot. For example: Parking lot “Atidim”, Floor 3, parking spot 123. Once the location of the first EV in the charging queue is tracked, at step 810 a charging cart (such as charging cart 101) is sent to the tracked location and charges said EV (which is the first EV in the charging queue). Once the charging of the EV is done, said charged EV is removed from the charging queue. At step 812, steps 808 and 810 are repeated, and the location of the next EV in the charging queue, now being the first EV in the charging queue is tracked and the charging cart is sent to the tracked EV and charges said EV. According to some embodiments, steps 808 and 810 are repeated until the charging queue is empty and all the EVs in the charging queue have been charged. In case the charging cart is discharged and needs to be charged to allow continuation of the EVs charging, the charging of the EVs is holed and continues after the charging cart is charged again and can charge the rest of the EVs in the charging queue.

At step 812, once the charging queue is empty, the charging cart automatically returns to the charging station, and the charging of the cart is managed to be optimally charged by prioritizing charging in low-price hours and low electricity consumption hours.

According to some embodiments, in case the charging system includes more than one charging carts, steps 808 and 810 are conducted for the first EVs in the charging queue as the number of available charging cart. For example, if the charging system includes three charging carts which are all available, steps 808 and 810 are conducted for the first three EVs in the charging queue. Alternatively, if one of the charging carts is in the middle of charging another EV, and there are only two available charging carts, steps 808 and 810 are conducted for the first two EVs in the charging queue.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of non-transitory memory media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the description and claims of the application, the words “include” and “have”, and forms thereof, are not limited to members in a list with which the words may be associated.

As used herein, the term “about” may be used to specify a value of a quantity or parameter (e.g. the length of an element) to within a continuous range of values in the neighborhood of (and including) a given (stated) value. According to some embodiments, “about” may specify the value of a parameter to be between 80 % and 120 % of the given value. According to some embodiments, “about” may specify the value of a parameter to be between 90 % and 110 % of the given value. According to some embodiments, “about” may specify the value of a parameter to be between 95 % and 105 % of the given value.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, or components, but do not preclude or rule out the presence or addition of one or more other features, integers, steps, operations, elements, components, or groups thereof.

While a number of exemplary aspects and embodiments have been discussed above, those of skill in the art will recognize certain modifications, additions and sub-combinations thereof. It is therefore intended that the following appended claims and claims hereafter introduced be interpreted to include all such modifications, additions and sub-combinations as are within their true spirit and scope.

1. An autonomous and mobile charging system for electrical vehicles (EVs), comprising:
a reversed “L” shape charging cart comprising a lying part and a standing part wherein the lying part is longer than the standing part, and wherein the lying part is designed to be positioned under an EV while charging said EV; wherein said lying part comprises a battery and/or charging surface which is replaceable according to the EV type, energy and dimensions requirements; and wherein the standing part comprises a positioning sensor;
a processor configured to execute a code for managing charging of the EV by the charging system configured to:
identify a subscribed EV entering to a parking lot;
receive data from the EV or from a mobile device of said EV's user regarding charging state of said EV;
track said EV's parking location using the positioning sensor;
send the charging cart to said EV's parking location to charge said EV; and
automatically return the charging cart to a charging station and optimally charging the charging cart by prioritizing charging in low-price hours and low electricity consumption hours.

2. The charging system of claim 1, wherein subscription of an EV to the system is done through a dedicated application installed in the mobile device of the EV's user.

3. The charging system of claim 1, wherein the charging cart further comprising cables for connecting the EV to the charging system for charging the EV.

4. The charging system of claim 1, wherein the charging surface is wireless for charging the EV wirelessly.

5. The charging system of claim 1, wherein the charging cart further comprising a DC charger, for rapid charging.

6. The charging system of claim 1, wherein the standing part of the charging cart comprises an operating panel interface for operating the charging system.

7. The charging system of claim 6, wherein the operating panel interface comprises a screen.

8. The charging system of claim 7, wherein the screen is a touch screen.

9. The charging system of claim 7, wherein the screen is an LCD screen.

10. The charging system of claim 1, wherein the position sensor is a Lidar sensor.

11. The charging system of claim 1, wherein the position sensor is a GPS sensor.

12. The charging system of claim 1, wherein identifying a subscribed EV is done using LPR or GEO fencing.

13. The charging system of claim 2, wherein identifying a subscribed EV is done manually by the user, entering the EV's parking spot to the dedicated application.

14. The charging system of claim 1, further comprising one or more back-up batteries for replacing an empty battery, wherein while the battery is charging the EV, the back-up batteries are charged.

15. The charging system of claim 1, wherein the processor is a local processor.

16. The charging system of claim 1, wherein the processor is a remote server.

17. The charging system of claim 1, wherein the processor is a part of a cloud computing network.

18. The charging system of claim 1, wherein the processor is further configured to execute a code configured to:
a. identify a plurality of subscribed EV located at the parking lot;
b. receive additional information about the duration of parking and future travels and/or trips of the EV and creating a charging queue for the plurality of subscribed EVs in the parking lot, according to the received charging data and according to said received additional information;
c. track the parking location of the first EV in the charging queue, using one or more positioning sensors;
d. send the charging cart to said first EV's parking location, charging said first EV and removing the charged EV from the charging queue after the charging of the EV is done; and
e. repeat steps c and d until the charging queue is empty.

19. A method for managing an electric-vehicles (EVs) charging by the charging system of claim 1, the method comprising:
identifying a subscribed EV entering to a parking lot;
receiving information from the EV or from a mobile device of said EV user regarding charging state of said EV;
tracking said EV parking location using one or more positioning sensors; and
sending the charging cart to said EV's parking location to charge said EV; and
automatically returning the charging cart to a charging station and optimally charging the charging cart by prioritizing charging in low-price hours and low electricity consumption hours.

20. The method of claim 19, further comprising the steps of:
a. identifying a plurality of subscribed EV located at the parking lot;
b. receiving additional information about the duration of parking and future travels and/or trips of the EV and creating a charging queue for the plurality of subscribed EVs in the parking lot, according to the received charging data and according to said received additional information;
c. tracking the parking location of the first EV in the charging queue, using one or more positioning sensors;
d. sending the charging cart to said first EV's parking location, charging said first EV and removing the charged EV from the charging queue after the charging of the EV is done; and
e. repeating steps c and d until the charging queue is empty.
